(19) United States
(12) Patent Application Publication
(10) Pub. No.: US 2022/0206980 A1
(43) Pub. Date: Jun. 30, 2022

(54) Adapter

(71) Applicant: Shenzhen Chengyue Innovation Technology Co.,Ltd, Shenzhen, Guangdong (CN)

(72) Inventor: ZhanXing Lin, Shenzhen, Guangdong (CN)

(73) Assignee: Shenzhen Chengyue Innovation Technology Co.,Ltd, Shenzhen, Guangdong (CN)

(21) Appl. No.: 16/326,190

(22) PCT Filed: Aug. 16, 2017
(86) PCT No.: PCT/CN2017/097653

§ 371 Date: Nov. 5, 2021

(30) Foreign Application Priority Data
Aug. 16, 2016 (CN) CN201620888068.2
Jun. 3, 2017 (CN) CN201720635225.3
Aug. 15, 2017 (CN) CN201721018987.5
Aug. 15, 2017 (CN) CN201721021401.0

(51) Int. Cl. G06F 13/38; G06F 13/40; G06F 13/42; H01R 31/06

(52) U.S. Cl. CPC G06F 13/385; G06F 13/4068; H01R 2201/06; H01R 31/065; G06F 2213/0042; G06F 13/4282

(57) ABSTRACT

The present disclosure relates to the field of electrical peripherals, and more particularly to an adaptor. The adaptor of the present disclosure includes a plug for being inserted into an electronic device interface, and an interface for inserting an insertion end of an external device. The adaptor includes a conductive terminal group and an electronic component. The conductive terminal group includes at least two conductive terminals, and the electronic component is connected to the at least two conductive terminals respectively. The adaptor of the present disclosure realizes the communication with the electronic device port by connecting the electronic components to two conductive terminals, which realizes the conversion between two different types of interfaces and greatly reduces the production cost of the adaptors.

### TECHNICAL HELD

The present disclosure relates generally to the field of electrical peripherals, and more particularly to an adaptor.

### BACKGROUND

Currently, the highest transmission rate of the Type-C port is 10 Gb/s. It can be used for data transmission, charging, or used as a video output port connecting to an external display device. It can perform bi-directional transmission and is compatible with conventional USB standards. The Type-C port has gradually become a regular design for electronic devices. However, there is still a large part of conventional USB plugs in the market. In order to realize communication and charging between the conventional USB plug and electronic devices with the Type-C port, the adaptor has emerged in the market.

However, a PCB board is required for the adaptors in the prior art to carry electronic components to achieve communication with the Type-C interface, which results a high cost of manufacture.

### SUMMARY

To overcome the defect of the existing adaptors, the present disclosure provides an adaptor.

To solve the technical problem, an embodiment of the present disclosure provides an adaptor. The adaptor includes a plug for being inserted into an electronic device interface, and an interface for inserting an insertion end of an external device. The adaptor includes a conductive terminal group and an electronic component. The conductive terminal group includes at least two conductive terminals, and the electronic component is connected to the at least two conductive terminals respectively.

Preferably, the plug is a Type-C plug, the interface is an USB interface. Two ends of the electronic component are respectively disposed on the at least two conductive terminals. The at least two conductive terminals are respectively the conductive terminal for detection signal communication and the conductive terminal for ground signal communication.

Preferably, the plug is a Type-C plug, the interface is a USB interface. When the conductive terminal group includes a structure of 5PIN to 4PIN terminal layout, the Type-C plug is 5PIN, and the USB interface is 4PIN. The 5PIN at the Type-C plug is respectively A1(B1), A5(B5), A6(B6), A7(B7) and A9(B9). The 4PIN at the USB interface is respectively USB(1), USB(2), USB(3), USB(4) or USB(5). A1(B1) is connected to USB(4) or USB(5), A7(B7) is connected to USB(2), A6(B6) is connected to USB(3), A9(B9) is connected to USB(1), and an end of the conductive terminal where A5(B5) is disposed, away from the Type-C plug, is nonconductive. The electronic component is electrically connected to the conductive terminal where A1(B1) is disposed and the conductive terminal where A5(B5) is disposed.

Preferably, the plug is the Type-C plug, the interface is the USB interface, When the conductive terminal group includes a structure of 10PIN to 9PIN terminal layout, the Type-C plug is 10PIN, the USB interface is 9PIN. The 10PIN at the Type-C plug is respectively B1(A1), B10(A10), B11(A11), B12(A12), A2(B2), A3(B3), A4(B4), A5(B5), A6(B6) and A7(B7). The 9PIN at the USB interface is respectively USB(1), USB(2), USB(3), USB(4), USB(5), USB(6), USB(7), USB(8) and USB(9). B1(A1) is connected to USB(4), B10(A10) is connected to USB(5), B11(A11) is connected to USB(6), A2(B2) is connected to USB(9), A3(B3) is connected to USB(8), A4(B4) is connected to USB(1), A6(B6) is connected to USB(3), A7(B7)is connected to USB(2), B12(A12) is connected to A5(B5), and the electronic component is electrically connected to B12(A12) and A5(B5).

Preferably, the conductive terminal where A5(B5) is disposed defines a first protrusion at an end thereof, away from the Type-C plug and toward a direction of the conductive terminal where B12(A12) is disposed. The first protrusion is in contact with one end of the conductive terminal where B12(A12) is disposed, away from the Type-C plug. The electronic component is disposed at the end of the conductive terminal where the B12(A12) is disposed, away from the Type-C plug.

Preferably, the electronic component is an identification resistance or a control chip or a semiconductor encapsulation module.

Preferably, the plug and the interface are connected in an integrated way. One end of the at least two conductive terminals is arranged at the interface, the other end is arranged at the plug.

Preferably, the adaptor includes no PCB board.

Preferably, the length of the interface is in the range of 10-16 mm.

Preferably, the total length of the adaptor is in the range of 18-24 mm.

Compared with the prior arts, the adaptor of the present disclosure realizes the communication with the electronic device port by connecting the electronic components to two conductive terminals, which realizes the conversion between two different types of interfaces and greatly reduces the production cost of the adaptors.

The adaptor of the present disclosure can perform the functions of detecting the Type-C port connection and/or identifying the insertion direction of the adaptor.

The adaptor of the present disclosure can realize the communication with the Type-C port, being plugged in both normal and reverse way.

The adaptor of the present disclosure can convert the existing Micro USB, USB 1.0, USB 2.0, USB 3.0 and USB 3.1 to Type-C, which has strong compatibility.

The adaptor of the present disclosure includes an interface and a plug which are integrally connected. The appearance of the adaptor is more compact, which is convenient to carry and more in line with the trend of ultra-thin and miniaturization of electronic devices.

There is no PCB board in the adaptor of the present disclosure, which reduces the production cost of the adaptor and reduces the length of the adaptor.

The length of the interface end of the adaptor of the present disclosure is only 10-16 mm, which is more in line with the trend of ultra-thin and miniaturization of electronic devices.

The total length of the adaptor of the present disclosure is 18-24 mm. Compared with the existing adaptors, the adaptor of the present disclosure has a smaller volume, which is convenient to carry and more in line with the trend of ultra-thin and miniaturization of electronic devices.

### BRIEF DESCRIPTION OF THE DRAWINGS

FIG. 1a is a perspective view of an adaptor according to a first embodiment of the present disclosure viewed from a first direction.

FIG. 1b is a perspective view of the adaptor according to the first embodiment of the present disclosure viewed from a second direction.

FIG. 2 is an exploded schematic diagram of the adaptor according to the first embodiment of the present disclosure.

FIG. 3a is a front view of a first terminal module according to the first embodiment of the present disclosure.

FIG. 3b is a bottom view of the first terminal module according to the first embodiment of the present disclosure,

FIG. 3c is an exploded schematic diagram of the first terminal module according to the first embodiment of the present disclosure.

FIG. 3d is an enlarged view of a conductive terminal group shown in FIG. 3c.

FIG. 4 is a perspective view of a first terminal mounting plate according to the first embodiment of the present disclosure.

FIG. 5 is a perspective view of a second terminal mounting plate according to the first embodiment of the present disclosure.

FIG. 6a is a schematic diagram of the adaptor according to the first embodiment of the present disclosure viewed from a first direction.

FIG. 6b is a schematic diagram of the adaptor according to the first embodiment of the present disclosure viewed from a second direction.

FIG. 7a is a perspective view of the adaptor according to a second embodiment of the present disclosure.

FIG. 7b is a front view of the adaptor according to the second embodiment of the present disclosure.

FIG. 8 is an exploded schematic diagram of the adaptor according to the second embodiment of the present disclosure.

FIG. 9 is an exploded schematic diagram of a terminal module according to the second embodiment of the present disclosure.

FIG. 10 is a schematic diagram of a first conductive terminal group according to the second. embodiment of the present disclosure.

FIG. 11 is a schematic diagram of a second conductive terminal group according to the second embodiment of the present disclosure.

FIG. 12a is a schematic diagram of a pin layout of conductive terminals according to the second embodiment of the present disclosure.

FIG. 12b is a schematic diagram of the pin layout of conductive terminals according to the second embodiment of the present disclosure viewed from another direction.

FIG. 13 is a perspective view of the second terminal mounting plate according to the second embodiment of the present disclosure.

FIG. 14 is a perspective view of the first terminal mounting plate according to the second embodiment of the present disclosure.

FIG. 15a is a schematic diagram of the adaptor according to the second embodiment of the present disclosure viewed from a first direction.

FIG. 15b is a schematic diagram of the adaptor according to the second embodiment of the present disclosure viewed from a second direction.

### DETAILED DESCRIPTION

In order to make the objectives, technical solutions, and advantages of the present disclosure clearer, the present disclosure is further described in detail below with reference to the accompanying drawings and embodiments. It should be understood that the specific embodiments described herein are provided for illustration only, and not for the purpose of limiting the invention.

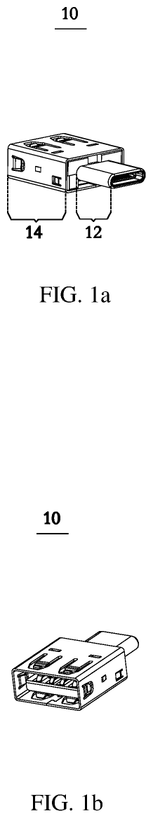

Referring to FIGS. 1a and 1b, a first embodiment of the present disclosure provides an adaptor 10 for converting a Type-C interface to an USB interface. The adaptor 10 includes a Type-C plug 12 and an USB interface 14 which are connected. The Type-C plug 12 is configured to be inserted into the Type-C interface of an electronic device. The USB interface 14 is configured for inserting an USB plug of an external apparatus, thereby converting the Type-C interface to the USB interface, so that the external apparatus with the USB plug and the electronic device with the Type-C interface can communicate or transmit power therebetween. The USB interface 14 can be an USB 1.0 interface, an USB 2.0 interface or a Micro USB interface. The Type-C plug 12 and the USB interface 14 can be connected in an integrated way, or via wires. Preferably, the Type-C plug 12 and the USB interface 14 are connected in an integrated way.

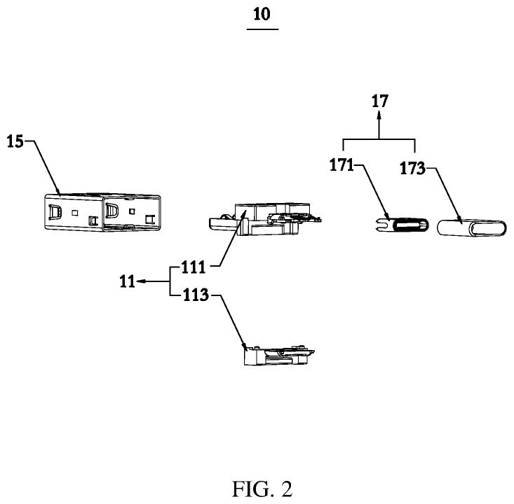

Referring to FIG. 2, the adaptor 10 specifically includes a terminal module 11, an USB shell 15, and a Type-C shell 17. The terminal module 11 defines a Type-C pin layout at an end, and an USB pin layout at the opposite end. The end of the terminal module 11 defining the USB pin layout is fixedly connected to the USB shell 15, to form the USB interface 14. The other end of the terminal module 11 defining the Type-C pin layout is fixedly connected to the Type-C shell 17, to form the Type-C plug 12. The terminal module 11 includes a first terminal module 111 and a second terminal module 113. The Type-C shell 17 includes a Type-C inner shell 171 and a Type-C outer shell 173. The first terminal module 111 and the second terminal module 113 are arranged separately and connected by overlapping. The Type-C inner shell 171 and the terminal module 11 are fixedly connected at an end of the Type-C plug 12 away from the USB interface 14. Preferably, they are connected by clamping. The Type-C outer shell 173 and the terminal module 11 are fixedly connected at an end of the Type-C plug 12 close to the USB interface 14, so as to accommodate an end of the terminal module 11 at the Type-C plug 12 and the Type-C inner shell 171.

Referring to HQ's, 3a, 3b and 3c, the first terminal module 111 includes a conductive terminal group 1111, a first terminal mounting plate 1113, an electronic component 1115 and a Type-C port fixing plate 1117. The conductive terminal group 1111 includes multiple conductive terminals which are mutually insulated. Preferably, the conductive terminals are integrally formed. The conductive terminal group 1111 defines an USB pin layout at an end, and a Type-C pin layout at the opposite end. The conductive terminal group 1111 is connected to the first terminal mounting plate 1113. Both ends of the conductive terminal group 1111 extend beyond the first terminal mounting plate 1113. Preferably, they are fixedly connected by injection moulding. The Type-C port fixing plate 1117, the end of the conductive terminal group 1111 defining the Type-C pin layout and the first terminal mounting plate 1113 are overlapped and connected at the end of the Type-C plug 12. Wherein, the end of the conductive terminal group 1111 defining the Type-C pin layout is disposed, between the Type-C port fixing plate 1117 and the first terminal mounting plate 1113. The Type-C port fixing plate 1117 is configured to fixedly connect to the Type-C charging port of the electronic device, so as to ensure the stability of the electrical connection after the adaptor 10 is inserted into the Type-C charging port of the electronic device. It can be understood that the Type-C port fixing plate 1117 can be omitted. The electronic component 1115 is electrically connected to the conductive terminal group 1111. Preferably, they are fixed by welding. The electronic component 1115 performs the function of identifying. When the adaptor 10 is inserted into the Type-C charging port of the electronic device, the electronic device can detect the insertion of the adaptor 10 by means of the electronic component 1115, and/or identify if the insertion direction of the adaptor 10 is normal or reverse. The electronic component 1115 is preferably an identification resistance or a control chip or a semiconductor encapsulation module. In this embodiment, the first terminal mounting plate 1113 and the Type-C port fixing plate 1117 are made of insulated materials.

The pin layout of the conductive terminal group 1111 at the USB interface 14 is specifically USB(1), USB(2), USB(3), USB(4), the pin layout at the Type-C plug 12 is specifically A1(B1), A5(B5), A6(B6), A7(B7), A9(B9). Wherein, A1(B1) is connected to USB(4), A7(B7) is connected to USB(2), A6(B6) is connected to USB(3), A9(B9) is connected to USB(1). That is, A1(B1) and USB(4) are disposed on an integrally formed conductive terminal, A7(B7) and USB(2) are disposed on an integrally formed conductive terminal, A6(B6) and USB(3) are disposed on an integrally formed conductive terminal, A9(B9) and USB(1) are disposed on an integrally formed conductive terminal. Wherein, an end of the conductive terminal where A5(B5) is disposed, away from the Type-C plug 12, is non-conductive. It can be understood that the non-conductive way can be that, the end of the conductive terminal where A5(B5) is disposed, away from the Type-C plug 12, is embedded in an end of the first terminal mounting plate 1113 at the USB interface 12, alternatively, the end of the conductive terminal away from the Type-C plug 12 does not extend to the USB interface 14. In this embodiment, preferably, the end of the conductive terminal where A5(B5) is disposed, away from the Type-C plug 12, is embedded in the end of the first terminal mounting plate 1113 at the USB interface 12. The electronic component 1115 is connected to the conductive terminal where A5(B5) is disposed and the conductive terminal where A9(B9) is disposed. That is, the electronic component 1115 is connected to the conductive terminal for detection signal communication (i.e. CC port) and the conductive terminal for ground signal communication (i.e. Ground port) respectively. Wherein, the port communication which four pins of the USB interface 14 and five pins of the Type-C plug 2 respectively perform belongs to the existing standards, and therefore will not be described herein.

It can be understood that, when the USB interface 14 is a Micro USB interface, the USB interface 14 has five pins, respectively, USB(1), USB(2), USB(3), USB(4), USB(5). At this time, A1(B1) is connected to USB(5), A7(B7) is connected to USB(2), A6(B6) is connected to USB(3), A9(B9) is connected to USB(1), and USB(4) is reserved for OTG (On the Go) startup.

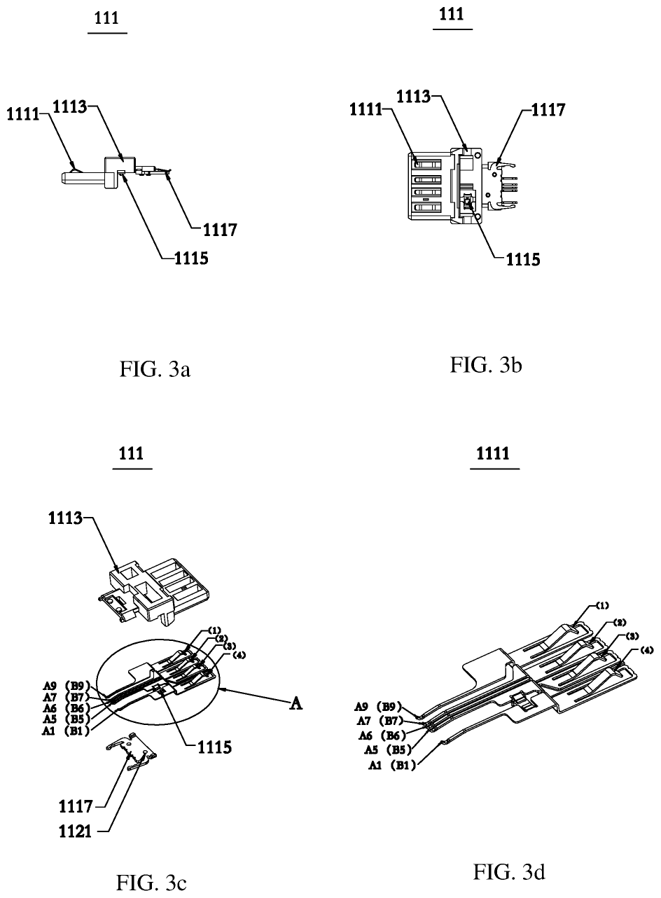

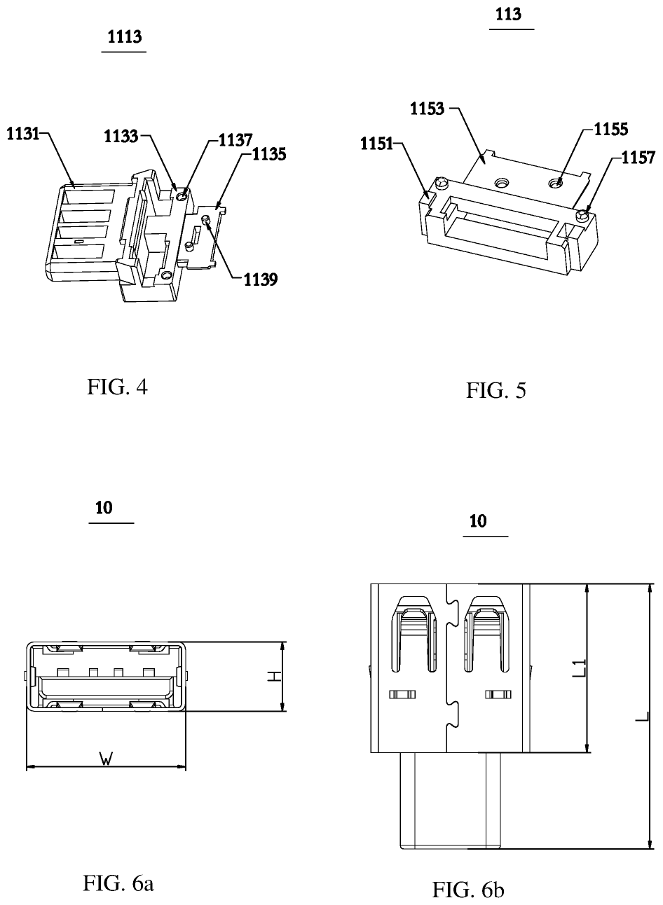

As shown in FIG. 4, the first terminal mounting plate 1113 includes an USB terminal plate 1131, a first connecting plate 1133 and an upper Type-C terminal plate 1135 which are connected. The upper Type-C terminal plate 1135 and the USB terminal plate 1131 are connected through the first connecting plate 1133. The first terminal mounting plate 1113 can be integrally formed. Alternatively, the USB terminal plate 1131, the first connecting plate 1133 and the upper Type-C terminal plate 1135 are separately formed, and fixed by glue adhesion or clamping connection. The first connecting plate 1133 defines a first positioning hole 1137 to limit the position with the second terminal module 113. The upper Type-C terminal plate 1135 defines a first positioning column 1139 on the surface thereof close to the conductive terminal group 1111. The first positioning column 1139 avoids the conductive terminals. As shown in FIG. 3c, the Type-C port fixing plate 1117 defines a first through hole 1121. The first through hole 1121 respectively corresponds to the first positioning column 1139. The Type-C port fixing plate 1117 and the upper Type-C terminal plate 1135 are overlapped and positioned through the first through hole 1121 and the first positioning column 1139,

Referring to FIG. 5, the second terminal module 113 includes a second connecting plate 1151 and a lower Type-C terminal plate 1153 which are integrally formed. The second connecting plate 1151 defines a second positioning column 1157 on the surface thereof close to the first terminal module 111. The second positioning column 1157 corresponds to the first positioning hole 1137. The second connecting plate 1151 and the first connecting plate 1133 are overlapped and positioned through the second positioning column 1157 and the first positioning hole 1137. The lower Type-C terminal plate 1153 defines a second positioning hole 1155 on the surface thereof close to the first terminal module 111, The second positioning hole 1155 corresponds to the first positioning column 1139. The lower Type-C terminal plate 1153 and the upper Type-C terminal plate 1135 are overlapped and positioned through the first positioning column 1139 and the second positioning hole 1155. It can be understood that the conductive terminal group 1111 can also be disposed in the second terminal module 113. In addition, it can be understood that one of the first terminal module 111 and the second terminal module 113 defines the positioning column, and the other correspondingly defines the positioning hole; or both of the first terminal module 111 and the second terminal module 113 define the positioning column and the positioning hole, and the positioning column corresponds to the positioning hole. Wherein, the Type-C port fixing plate 1117 overlaps the terminal module provided with the positioning column, so that the Type-C port fixing plate 1117 is clamped between the upper Type-C terminal plate 1135 and the lower Type-C terminal plate 1153.

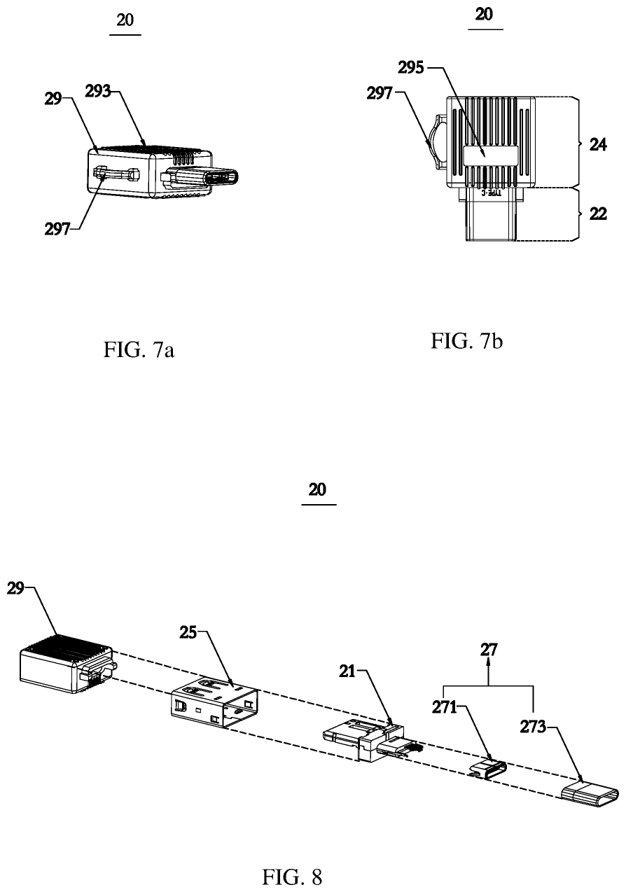

Referring to FIGS. 6a and 6b, the total length L of the adaptor 10 in the first embodiment of the present disclosure is in the range of 18-24 mm, preferably 21.5-225 mm, further preferably 21.85 mm. The total width W is in the range of 12-15 mm, preferably 12.5-13.5 mm, further preferably 13.1 mm. The total height H is in the range of 5-8 mm, preferably 5.5-6.2 mm, further preferably 5.72 mm. The length L1 of the USB interface 14 is in the range of 10-16 mm, preferably 12.5-15.5 mm, further preferably 13.9 mm. The adaptor 10 of the present disclosure has no PCB to carry the electronic component 1115, and the first terminal module 111 and the second terminal module 113 are overlapped and connected. Therefore, the adaptor 10 has a very small volume and is convenient to carry, which is more suitable for the trend of lighter and thinner electronic devices.

Referring to FIGS. 7a and 7b, a second embodiment of the present disclosure provides another adaptor 20. The structure of the adaptor 20 of this embodiment and the adaptor 10 of the first embodiment are basically the same, and there are only differences in details. The differences between the adaptor 20 and the adaptor 10 will be described in details below, and the similarities will not be described herein.

Referring to FIGS. 7a, 7b, and 8, the adaptor 20 further includes an outer shell 29. The outer shell 29 is sleeved around an USB shell 25 and is fixedly coupled thereto. The outer shell 29 provides a decorative strip 293 on an outer surface thereof. The decorative strip 293 can be designed in a variety of shapes to meet the aesthetic needs of different consumers. A LOGO pasting area 295 is provided in a middle area surrounded by the decorative strip 293, so as to facilitate the manufacturer or the seller to affix their own trademark or LOGO. The outer shell 29 provides a handle 297 on a side thereof, for easily carrying and accessing the adaptor 20.

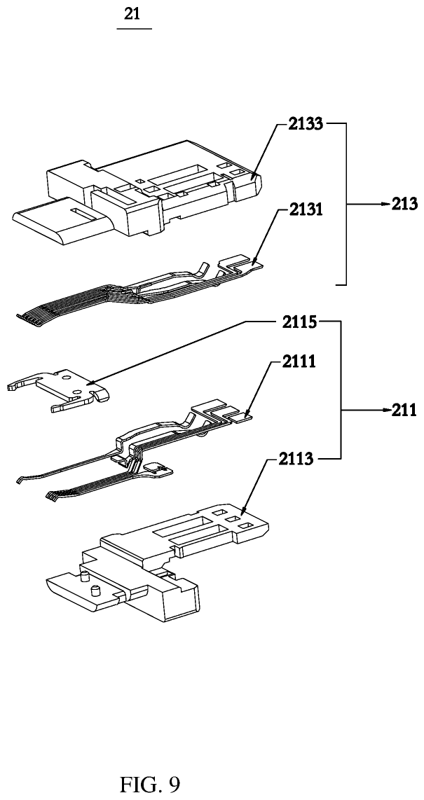

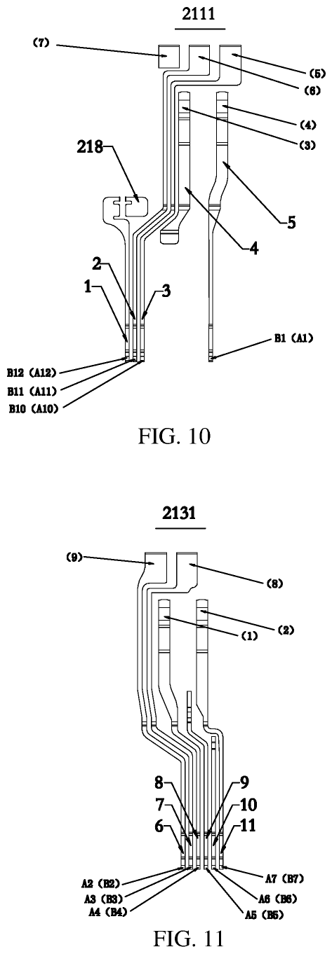

Referring to FIGS. 9 and 10, the adaptor 20 includes a terminal module 21. The terminal module 21 includes a first terminal module 211 and a second terminal module 213 which are connected by overlapping. The first terminal module 211 includes a first terminal mounting plate 2113, a first conductive terminal group 2111 and a Type-C port fixing plate 2115. The first conductive terminal group 2111 includes five conductive terminals labeled 1, 2, 3, 4 and 5 which are mutually insulated, wherein the four conductive terminals labeled 1, 2, 3, 5 respectively correspond to four pins B12(A12), B11(A11), B10(A10), B1(A1) at a Type-C plug 22. The four pins are at the same level. Therefore, in this embodiment, the four pins are collectively referred to as row B pins for easy description. The four conductive terminals labeled 2, 3, 4, 5 of the first conductive terminal group 2111 correspond to four pins USB(6), USB(5), USB(3) and USB(4) at an USB interface 24, respectively. Wherein, B1(A1) is connected to USB(4), B10(A10) is connected to USB(5), B11(A11) is connected to USB(6). B1(A1) and USB(4), B10(A10) and USB(5), B11(A11) and USB(6) are respectively disposed on an integrally-formed conductive terminal. However, the conductive terminal 1 where B12(A12) is disposed does not extend to the USB interface 24. An electronic component 215 is disposed on an end of the conductive terminal 1 where the B12(A12) is disposed, away from the Type-C plug 22. The conductive terminal 4 where USB(3) is disposed does not extend to the Type-C plug 22 either. The first terminal module 211 also includes a single pin USB(7) welded at the USB interface 24, preferably, the pin USB(7) is connected to the USB shell 25 for grounding,

Referring to FIGS. 9 and 11, the second terminal module 213 includes a second terminal mounting plate 2133 and a second conductive terminal group 2131. The second conductive terminal group 2131 includes six conductive terminals labeled 6, 7, 8, 9, 10 and 11 which are mutually insulated. The six conductive terminals labeled 6, 7, 8. 9, 10 and 11 respectively correspond to six pins A2(B2), A3(B3), A4(B4), A5(B5), A6(B6), A7(B7) at the Type-C plug 22. It is understood that the six pins are at the same level, Therefore, in this embodiment, the six pins are collectively referred to as row A pins for easy description. It can be understood that the row B pins and the row A pins are respectively at different levels at the Type-C plug; 22; wherein the four conductive terminals labeled 6, 7, 8, and 11 respectively correspond to four pins USB(9), USB(8), USB(1) and USB(2) at the USB interface 24. Wherein, A2(B2) is connected to USB(9), A3(B3) is connected to USB(8), A4(B4) is connected to USB(1), A7(B7) is connected to USB(2), A5(B5) is connected to B12(A12), A6(B6) is connected to USB(3), A2(B2) and USB(9), A3(B3) and USB(8), A4(B4)and USB(1), A7(B7) and USB(2) are respectively disposed on an integrally-formed conductive terminal. However, the conductive terminal 9 where A5(B5) is disposed does not extend to the USB interface 14. The conductive terminal 9 where A5(B5) is disposed and the conductive terminal 1 where B12(A12) is disposed are overlapped, so as to achieve the connection between the pins A5(B5) and B12(A12). The conductive terminal 10 where A6(B6) is disposed does not extend to the USB interface 14 either. the conductive terminal 10 where A6(B6) is disposed and the conductive terminal 4 where USB(3) is disposed are overlapped, so as to achieve the connection between the pins A6(B6) and USB(3). Therefore, the adaptor 20 in this embodiment has a structure of 10PIN to 9PIN terminal layout.

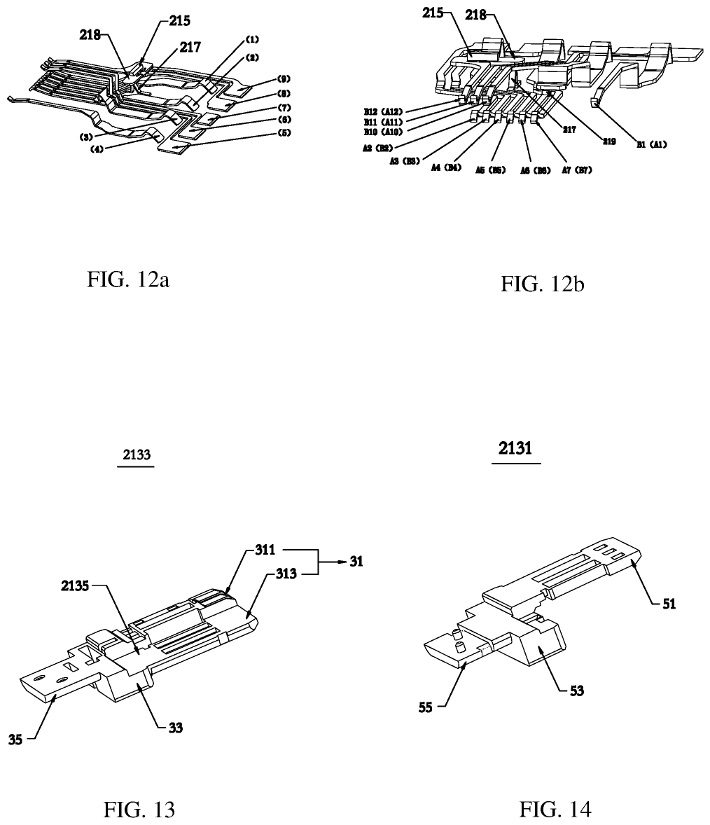

Referring to FIGS. 12a and 12b, B1(A1) and USB(4), B10(A10) and USB(5), B11(A11) and USB(6), A2(B2) and USB(9), A3(B3) and USB(8), A4(B4) and USB(1), A7(B7) and USB(2) are disposed on an integrally-formed conductive terminal. B12(A12) and A5(B5), A6(B6) and USB(3) are both electrically connected by overlapping two conductive terminals. The conductive terminal 9 where A5(B5) is disposed defines a first protrusion 217 at an end thereof, away from the Type-C plug 22 and toward a direction of the conductive terminal 1 where B12(A12) is disposed, so as to contact the conductive terminal 1 where B12(A12) is disposed, thereby achieving an electrical connection. Wherein, an end of the conductive terminal 1 where B12(A12) is disposed, away from the Type-C plug 22, is substantially elongated. After the electronic component 215 is fixedly connected to the elongated end, it is disconnected from the middle of the elongated end to prevent short circuit of the electronic component 215, thus forming an independent conductive sheet 218. The conductive sheet 218 is connected to the first protrusion 217. One end of the electronic component 215 is connected to the conductive sheet 218, while the other end is connected to the conductive terminal 1 where B12(A12) is disposed away from the Type-C plug 22. The electronic components 215 and the conductive terminals 9 where A5(B5) is disposed are respectively disposed on two opposite sides of the conductive sheet 218. Preferably, the height of the first protrusion 217 is in the range of 0.8-1.2 mm, which can ensure that the conductive terminal 9 where A5(B5) is disposed and the conductive terminal 1 where B12(A12) is disposed are contacted, and the conductive terminal 1 where B12(A12) is disposed is supported by the first protrusion 217 to ensure the stability of the electrical connection therebetween. The conductive terminal 10 where A6(B6) is disposed defines a second protrusion 219 at an end thereof, away from the Type-C plug 22 and toward a direction of the conductive terminal 4 where the USB(3) is disposed. One end of the conductive terminal 4 where the USB(3) is disposed away from the USB interface 24, is bent toward the conductive terminal 10 where A6(B6) is disposed. The second protrusion 219 is in contact with the bent end of the conductive terminal 4 where USB(3) is disposed, so as to achieve an electrical connection.

Referring to FIG. 13, a lower USB terminal plate 31 of the second terminal mounting plate 2133 includes a first plate 311 and a second plate 313 which are connected. The first plate 311 and the second plate 313 are arranged side by side. The thickness of the first plate 311 is larger than that of the second plate 313. Moreover, the thickness of the portion where a second connecting plate 33 and the second plate 313 are connected is smaller than that of the portion where the second connecting plate 33 and the first plate 311 are connected. The first plate 311 is used for installing the second conductive terminal group 2131. From the overall appearance, the second terminal mounting plate 2133 defines a vacant space 2135 to receive a portion of the first terminal mounting plate 2131.

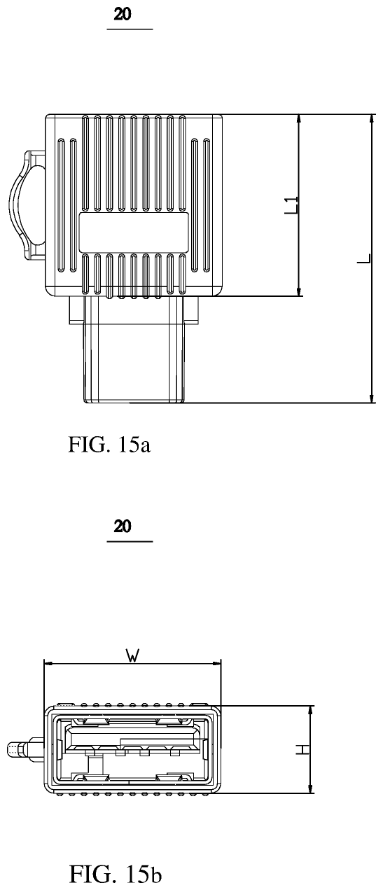

Referring to FIG. 14, the shape of an upper USB terminal plate 51 of the first terminal mounting plate 2111 is the same as that of the second plate 313. The sum of the thickness of the upper USB terminal plate 51 and the second plate 313 is the same as that of the first plate 311. When the first terminal mounting plate 2111 and the second terminal mounting plate 2113 are overlapped and limited, the upper USB terminal plate 51 is received in the vacant space. An upper Type-C terminal plate 55 fits a lower Type-C terminal plate 35, and the overall shape of the two fitted is a waist round plate. A Type-C inner shell 271 and a Type-C outer shell 273 are successively sheathed onto the waist round plate to form the Type-C plug 24. The upper USB terminal plate 51 is received. in the vacant space. The first connecting plate 53 and the second connecting plate 33 are buckled, then the USB shell 25 is sheathed to form the USB interface 24. In this embodiment, the USB interface 24 may be a USB 3.0 interface or a USB 3.1 interface.

Referring to FIGS. 15a and 15b, the total length L of the adaptor 20 in the second embodiment of the present disclosure is in the range of 18-24 mm, preferably 21.5-24 mm, more preferably 23.8 mm. The total width W is in the range of 12-15 mm, preferably 13.5-15 mm, more preferably 14.6 mm. The total height H is in the range of 5-8 mm, preferably 5.5-7.8 mm, more preferably 7.2 mm. The length Li of the USB interface 14 is in the range of 10-16 mm, preferably 12.5-15.5 mm, more preferably 15.5 mm.

In a word, in the first embodiment, the second embodiment and their variations of the present disclosure, the Type-C plug can be inserted in both normal and reverse way, without influencing signal communication. Additionally, a modular installation mode is employed in the first embodiment, the second embodiment and their variations of the present disclosure. Each of the conductive terminal groups is integrated onto the modular plate. Then the inner shell and the outer shell are successively sheathed by overlapping each modular plate, to form the adaptor, which has the advantages of high installation efficiency, low assembly cost, and the terminals are fixed in the module so that the terminals will not be dislocated, thereby improving the contact stability.

Compared with the prior arts, the adaptor of the present disclosure realizes the communication with the electronic device port by connecting the electronic components to two conductive terminals, which realizes the conversion between two different types of interfaces and greatly reduces the production cost of the adaptors.

The adaptor of the present disclosure can perform the functions of detecting the Type-C port connection and/or identifying the insertion direction of the adaptor.

The adaptor of the present disclosure can realize the communication with the Type-C port, being plugged in both normal and reverse way.

The adaptor of the present disclosure can convert the existing Micro USB, USB 1.0, USB 2.0, USB 3.0 and USB 3.1 to Type-C, which has strong compatibility.

The adaptor of the present disclosure includes an interface and a plug which are integrally connected. The appearance of the adaptor is more compact, which is convenient to carry and more in line with the trend of ultra-thin and miniaturization of electronic devices.

There is no PCB board in the adaptor of the present disclosure, which reduces the production cost of the adaptor and reduces the length of the adaptor.

The length of the interface end of the adaptor of the present disclosure is only 10-16 mm, which is more in line with the trend of ultra-thin and miniaturization of electronic devices.

The total length of the adaptor of the present disclosure is 18-24 mm. Compared with the existing adaptors, the adaptor of the present disclosure has a smaller volume, which is convenient to carry and more in line with the trend of ultra-thin and miniaturization of electronic devices.

The foregoing descriptions are only preferred embodiments of the present disclosure, rather than to limit the present disclosure. Any modifications, equivalent replacements and improvements made within the spirits and principles of the present disclosure shall be included in the protection scope of the present disclosure.

1. An adaptor, comprising a plug for being inserted into an electronic device interface, and an interface for inserting an insertion end of an external device; the adaptor comprising a conductive terminal group and an electronic component, the conductive terminal group comprising at least two conductive terminals, and the electronic component being connected to the at least two conductive terminals respectively.

2. The adaptor according to claim 1, wherein the plug is a Type-C plug, the interface is an USB interface, two ends of the electronic component are respectively disposed on the at least two conductive terminals, and the at least two conductive terminals are respectively the conductive terminal for detection signal communication and the conductive terminal for ground signal communication.

3. The adaptor according to claim 1, wherein the plug is a Type-C plug, the interface is a USB interface, when the conductive terminal group comprises a structure of 5PIN to 4PIN terminal layout, the Type-C plug is 5PIN, and the USB interface is 4PIN, which the 5PIN at the Type-C plug is respectively A1(B1), A5(B5), A6(B6), A7(B7) and A9(B9), the 4PIN at the USB interface is respectively USB(1), USB(2), USB(3), USB(4) or USB(5); A1(B1) is connected to USB(4) or USB(5), A7(B7) is connected to USB(2), A6(B6) is connected to USB(3), A9(B9) is connected to USB(1), and an end of the conductive terminal where A5(B5) is disposed, away from the Type-C plug, is nonconductive, the electronic component is electrically connected to the conductive terminal where A1(B1) is disposed and the conductive terminal where A5(B5) is disposed.

4. The adaptor according to claim 1, wherein the plug is the Type-C plug, the interface is the USB interface, when the conductive terminal group comprises a structure of 10PIN to 9PIN terminal layout, the Type-C plug is 10PIN the USB interface is 9PIN, which the 10PIN at the Type-C plug is respectively B1(A1), B10(A10), B11(A1), B12(A12), A2(B2), A3(B3), A4(B4), A5(B5), A6(B6) and A7(B7), the 9PIN at the USB interface is respectively USB(1), USB(2), USB(3), USB(4), USB(5), USB(6), USB(7), USB(8) and USB(9), B1(A1) is connected to USB(4), B10(A10) is connected to USB(5), B11(A11) is connected to USB(6), A2(B2) is connected to USB(9), A3(B3) is connected to USB(8), A4(B4) is connected to USB(1), A6(B6) is connected to USB(3), A7(B7)is connected to USB(2), B12(A12) is connected to A5(B5), and the electronic component is electrically connected to B12(A12) and A5(B5).

5. The adaptor according to claim 4, wherein the conductive terminal where A5(B5) is disposed. defines a first protrusion at an end thereof, away from the Type-C plug and toward a direction of the conductive terminal where B12(A12) is disposed, the first protrusion is in contact with one end of the conductive terminal where B12(A12) is disposed, away from the Type-C plug; and the electronic component is disposed at the end of the conductive terminal where the B12(A12) is disposed, away from the Type-C plug.

6. The adaptor according to claim 1, wherein the electronic component is an identification resistance or a control chip or a semiconductor encapsulation module.

7. The adaptor according to claim 1, wherein the plug and the interface are connected in an integrated way, one end of the at least two conductive terminals is arranged at the interface, the other end is arranged at the plug.

8. The adaptor according to claim 1, wherein the adaptor comprises no PCB board.

9. The adaptor according to claim 1, wherein the length of the interface is in the range of 10-16 mm.

10. The adaptor according to claim 1, wherein the total length of the adaptor is in the range of 18-24 mm.
